(19) United States
(12) Patent Application Publication
(10) Pub. No.: US 2008/0297468 A1
(43) Pub. Date: Dec. 4, 2008

(54) Liquid Crystal Display Apparatus Including a Photosensor

(76) Inventors: Kee-Chan PARK, Anyang-si (KR); Jun-Ho SONG, Seongnam-si (KR); Shang-Min YHEE, Seoul (KR); Doo-Hyung WOO, Anyang-si (KR); Zhi-Feng ZHAN, Yongin-si (KR); Seong-Il PARK, Seoul (KR); Seung-Kyu LEE, Suwon-si (KR); Yang-Hwa CHOI, Yongin-si (KR)

Correspondence Address: F. CHAU & ASSOCIATES, LLC, 130 WOODBURY ROAD, WOODBURY, NY, 11797, US

(21) Appl. No.: 12/132,231

(22) Filed: Jun. 3, 2008

(30) Foreign Application Priority Data
Jun. 4, 2007 (KR) 2007-54284

(51) Int. Cl. G02F 1/13357; G09G 3/36

(52) U.S. Cl. 345/102; 349/116

(57) ABSTRACT

A liquid crystal display (LCD) apparatus includes a first substrate, a second substrate, a liquid crystal layer and a backlight assembly. The first substrate includes a display part and a sensor part. The sensor part is disposed in a peripheral area of the display part and senses external light. The second substrate is disposed opposite to the first substrate. The liquid crystal layer is disposed between the first substrate and the second substrate. The backlight assembly is disposed adjacent to the second substrate to expose the first substrate and to provide light. A light detecting function of the sensor part may be increased, so that the backlight may be used effectively and the power consumption of the display apparatus may be reduced.

### CROSS-REFERENCE TO RELATED APPLICATION

This application claims priority under 35 U.S.C. § 119 to Korean Patent Application No. 10-2007-0054284, filed on Jun. 4, 2007 in the Korean Intellectual Property Office (KIPO), the contents of which are herein incorporated by reference in their entirety.

### BACKGROUND OF THE INVENTION

1. Technical Field

The present invention relates to a liquid crystal display (LCD) apparatus. More particularly, the present invention relates to an LCD apparatus including a photo sensor.

2. Description of the Related Art

Flat panel display apparatuses include liquid crystal display (LCD) apparatuses, organic light-emitting display (OLED) apparatuses, plasma display panel (PDP) apparatuses and so on. Flat panel display apparatuses are typically thinner and lighter than other types of display apparatuses.

An LCD apparatus includes an array substrate, a color filter substrate and a liquid crystal layer. Thin-film transistors (TFTs) are formed on the array substrate. The liquid crystal layer is disposed between the array substrate and the color filter substrate, and has an anisotropic dielectric constant. An electric field is applied to the liquid crystal layer, and the intensity of the applied electric field controls an amount of light transmitted through the liquid crystal layer. An image is displayed by adjusting the intensity of the applied electric field.

The LCD apparatus does not emit light by itself. Thus, the LCD apparatus requires an external light source. A backlight assembly provides the LCD apparatus with light.

In battery operated portable electronic devices including LCD apparatuses, such as portable computers and mobile phones, it is important that battery power last as long as possible. An LCD backlight assembly may be responsible for a large portion of battery drain in portable electronic devices using LCD apparatuses, thereby making it difficult to achieve long battery life.

### SUMMARY OF THE INVENTION

Exemplary embodiments of the present invention provide a liquid crystal display (LCD) apparatus having a photosensor capable of increasing photosensing characteristics.

In exemplary embodiments of the present invention, an LCD apparatus includes a first substrate, a second substrate, a liquid crystal layer and a backlight assembly. The first substrate includes a display part and a sensor part. The sensor part is disposed in a peripheral area of the display part and senses external light. The second substrate is disposed opposite to the first substrate. The liquid crystal layer is disposed between the first substrate and the second substrate. The backlight assembly is disposed adjacent to the second substrate and provides light. The LCD apparatus may further include a control part. The control part controls an amount of light supplied from the backlight assembly according to a light intensity detected by the sensor part.

The sensor part may include a switching device and a sensor device. Each of the switching device, the sensor device and the display part includes a polysilicon layer, a gate electrode and a drain electrode. The polysilicon layer includes a first doped part, a channel part and a second doped part. The gate electrode is formed on the channel part, and the drain electrode makes contact with the second doped part.

The first doped part of the sensor part may be doped as p-type, and the second doped part of the sensor part may be doped as n-type. A light-blocking layer may be formed under the polysilicon layer of the display part of the first substrate. A protective layer may be formed on the switching device of the display part of the first substrate, the protective layer covering the switching device. A color filter layer may be formed on the protective layer.

The LCD apparatus may further include a driving circuit substrate. The driving circuit substrate drives the display part, and is disposed between the sensor part and the backlight assembly to block light. A driving chip may be mounted on the driving circuit substrate, and the driving chip of the driving circuit substrate may be disposed under the sensor part to block light.

The LCD apparatus may further include a light-blocking part between the sensor part and the backlight assembly. The light-blocking part may be formed as a thin-film adhering to the sensor part. An adhesive member may be disposed between the sensor part and the light-blocking part to adhere the sensor part to the light-blocking part.

The backlight assembly may include a light source at a side of the backlight assembly, and the sensor part may be disposed at an opposite side of the light source with respect to the display part.

The LCD apparatus may further include a mold frame receiving the backlight assembly and an LCD panel. The mold frame may include a partition disposed between the backlight assembly and the sensor part to prevent light from leaking to the sensor part. The LCD apparatus may further include a color filter layer formed on the second substrate.

In an exemplary embodiment of the present invention, an LCD apparatus includes an LCD panel, a backlight assembly, a driving circuit and a control part. The LCD panel includes a first substrate, a second substrate and a liquid crystal layer. The first substrate includes a display part displaying an image and a sensor part disposed in a peripheral area of the display part and sensing light. The second substrate is disposed opposite to the first substrate. The liquid crystal layer is disposed between the first substrate and the second substrate. The backlight assembly is disposed adjacent to the second substrate of the LCD panel and provides the liquid crystal with light. The driving circuit substrate drives the LCD panel. The control part controls an amount of light supplied from the backlight assembly according to an intensity of light detected by the sensor part of the LCD panel.

The driving circuit substrate may be disposed between the sensor part and the backlight assembly to block light. The driving circuit substrate may include a driving chip, and the driving chip of the driving circuit substrate may be disposed under the sensor part to block light.

The backlight assembly may include a light source at a side of the backlight assembly, and the sensor part may be disposed at an opposite side of the light source with respect to the display part.

The backlight assembly may further include a mold frame receiving the backlight assembly and the LCD panel. The mold frame has a partition, and the partition is disposed between the backlight assembly and the sensor part to prevent light from leaking to the sensor part.

Accordingly, a light detecting function of the sensor part may be increased and the backlight may be used effectively and the power consumption of the display apparatus may be reduced.

### BRIEF DESCRIPTION OF THE DRAWINGS

The above and other aspects of exemplary embodiments of the present invention will become readily apparent by reference to the following detailed description when considered in conjunction with the accompanying drawings wherein:

FIG. 1 is an exploded perspective view illustrating a liquid crystal display (LCD) apparatus in accordance with an exemplary embodiment of the present invention;

FIG. 2 is a cross-sectional view illustrating an LCD apparatus in accordance with an exemplary embodiment of the present invention;

FIG. 3 is an enlarged cross-sectional view illustrating a portion ‘A’ in FIG. 2;

FIG. 4 is an enlarged cross-sectional view illustrating a portion ‘B’ in FIG. 2;

FIG. 5 is an exploded perspective view illustrating an LCD apparatus in accordance with an exemplary embodiment of the present invention;

FIG. 6 is an exploded perspective view illustrating an LCD apparatus in accordance with an exemplary embodiment of the present invention;

FIG. 7 is an exploded perspective view illustrating an LCD apparatus in accordance with an exemplary embodiment of the present invention;

FIG. 8 is a cross-sectional view illustrating a first substrate of an LCD apparatus in accordance with an exemplary embodiment of the present invention;

FIG. 9 is a cross-sectional view illustrating a first substrate of an LCD apparatus in accordance with an exemplary embodiment of the present invention; and

FIG. 10 is a cross-sectional view illustrating a first substrate and a second substrate of an LCD apparatus in accordance with an exemplary embodiment of the present invention.

### DETAILED DESCRIPTION OF THE EXEMPLARY EMBODIMENTS

Exemplary embodiments of the present invention are described more fully hereinafter with reference to the accompanying drawings. This invention may, however, be embodied in many different forms and should not be construed as limited to the exemplary embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers may refer to like elements throughout. Hereinafter, exemplary embodiments of the present invention will be explained in detail with reference to the accompanying drawings.

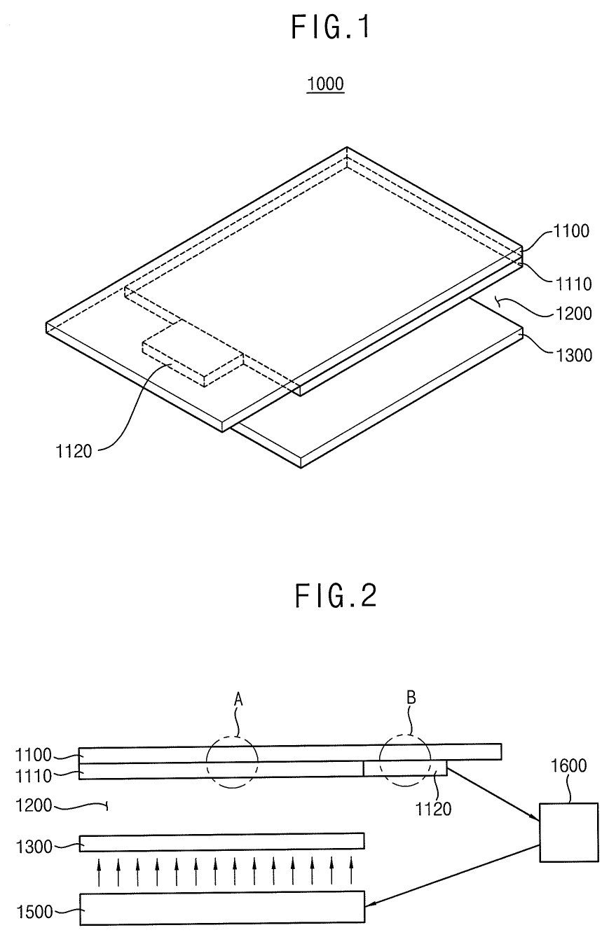

FIG. 1 is an exploded perspective view illustrating a liquid crystal display (LCD) apparatus in accordance with an exemplary embodiment of the present invention.

Referring to FIG. 1, an LCD apparatus 1000 includes a first substrate 1100, a second substrate 1300 and a liquid crystal layer 1200. The liquid crystal layer 1200 is disposed between the first substrate 1100 and the second substrate 1300. The first substrate 1100 includes a display part 1110 and a sensor part 1120. The display part 1110 displays an image using liquid crystals of the liquid crystal layer 1200. The sensor part 1120 is disposed in a peripheral area of the display part 1110 and detects external light.

The first substrate 1100 is exposed to the exterior of the apparatus 1000, so that the sensor part 1120 is also exposed to the exterior of the apparatus 1000.

FIG. 2 is a cross-sectional view illustrating an LCD apparatus in accordance with an exemplary embodiment of the present invention.

Referring to FIG. 2, an LCD apparatus 1000 includes a first substrate 1100, a second substrate 1300, a liquid crystal layer 1200, a backlight assembly 1500 and a control part 1600. The liquid crystal layer 1200 is disposed between the first substrate 1100 and the second substrate 1300. The first substrate 1100 includes a display part 1110 and a sensor part 1120. The display part 1110 displays an image. The sensor part 1120 is disposed in a peripheral area of the display part 1110 and detects ambient light.

The backlight assembly 1500 is disposed under the second substrate 1300 and provides light to the second substrate 1300. The control part 1600 controls an amount of light supplied from the backlight assembly according to an intensity of the light detected by the sensor part 1120.

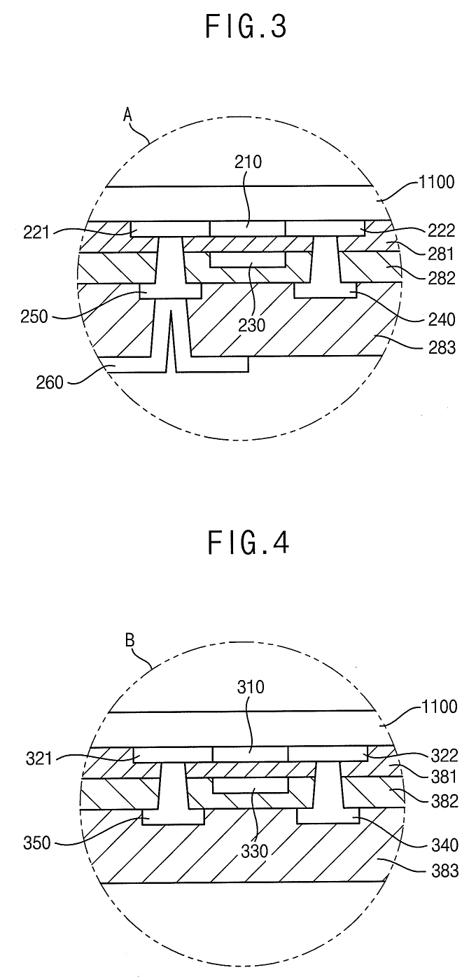

FIG. 3 is an enlarged cross-sectional view illustrating a portion ‘A’ in FIG. 2.

Referring to FIG. 3, a cross-section of a switching device of the display part 1110 is illustrated in FIG. 3.

The display part 1110 is formed on the first substrate 1100, and a polysilicon layer is formed in the display part 1110. The polysilicon layer includes a channel part 210 and doping parts 221 and 222 formed at two opposite sides of the channel part 210.

The doping parts 221 and 222 are doped with n-type impurities or p-type impurities after the polysilicon layer is formed, thereby forming the channel part 210 and doping parts 221 and 222.

A first insulation layer 281 is formed on the channel part 210 and doping parts 221 and 222, and a gate electrode 230 is formed on the first insulation layer 281.

A second insulation layer 282 is formed on the gate electrode 230, a source electrode 240 and a drain electrode 250 are formed on the second insulation layer 282. The source electrode 240 penetrates the insulation layers 281 and 282 and makes contact with the doping part 222. The source electrode 240 is electrically connected to the doping part 222. The drain electrode 250 penetrates the insulation layers 281 and 282 and makes contact with the doping part 221. The drain electrode 250 is electrically connected to the doping part 221.

A third insulation layer 283 is formed on the source electrode 240 and the drain electrode 250. A pixel electrode 260 is formed on the third insulation layer 283. The pixel electrode 260 penetrates the third insulation layer 283, and makes contact with the drain electrode 250. The pixel electrode 260 is electrically connected to the drain electrode 250.

The gate electrode 230 transfers a gate-on signal, and the source electrode 240 transfers a data voltage having an image signal. The switching device is turned on according to the gate-on signal transferred via the gate electrode 230. When the switching device is turned on, a data voltage transferred via the source electrode 240 is applied to each of the pixel electrodes 260. When the voltage is applied to the pixel electrode 260, the arrangement direction of liquid crystal disposed within the liquid crystal layer 1200 is changed, and accordingly, light transmission through the liquid crystal layer 1200 is changed. Thus, the image is displayed.

FIG. 4 is an enlarged cross-sectional view illustrating a portion ‘B’ in FIG. 2.

In FIG. 4, a cross-section of the sensor part 1120 is illustrated.

Referring to FIG. 4, the sensor part 1120 is formed on the first substrate 1100. A polysilicon layer is formed on the sensor part 1120. The polysilicon layer includes a channel part 310, a first doping part 321 and a second doping part 322. The first doping part 321 and the second doping part 322 are formed at two opposite sides of the channel part 310.

The doping parts 221 and 222 are doped with n-type impurities or p-type impurities after the polysilicon layer is formed, thereby forming the channel part 310, the first doping part 321 and the second doping part 322.

A first insulation layer 381 is formed on the channel part 310, the first doping part 321 and the second doping part 322. A gate electrode 330 is formed on the first insulation layer 381.

A second insulation layer 382 is formed on the gate electrode 330. A source electrode 340 and a drain electrode 350 are formed on the second insulation layer 382. The source electrode 340 penetrates the insulation layers and makes contact with the second doping part 322. The source electrode 340 is electrically connected to the second doping part 322. The drain electrode 350 penetrates the insulation layers and makes contact with the first doping part 321. The drain electrode 350 is electrically connected to the first doping part 321.

A third insulation layer 383 is formed on the source electrode 340 and the drain electrode 350.

The sensor part 1120 detects light. An electric current is generated according to an amount of ambient light incident on the polysilicon layer of the sensor part 1120. The polysilicon layer of the sensor part 1120 may be used as a light sensor.

However, a function of the light sensor depends on a light-receiving ratio and operating characteristics. The light-receiving ratio is defined as the extent to which a sensor receives light, and the operating characteristics are defined as how small of an intensity of light a sensor is capable of reacting to.

When the sensor part 1120 is disposed upside down with respect to the sensor part 1120 in FIG. 2 or when the channel part 310 faces inward, the light irradiated onto the sensor part 1120 is blocked by the gate electrode 330 and reaches the source electrode 240 and the drain electrode 250.

A metallic electrode is formed on the source electrode 240 and the drain electrode 250. Light may be irradiated onto a small area of the source electrode 240 and the drain electrode 250, which is not covered by the metallic electrode.

A light-receiving area is small when the sensor part 1120 is disposed upside down with respect to the sensor part 1120 in FIG. 2. In accordance with an exemplary embodiment of the present invention, the light may be directly irradiated onto the channel part 310, so that the light-receiving area may be increased. The structure of the exemplary embodiment of the present invention may increase the light-receiving ratio of the channel part 310 and may detect a small amount of light.

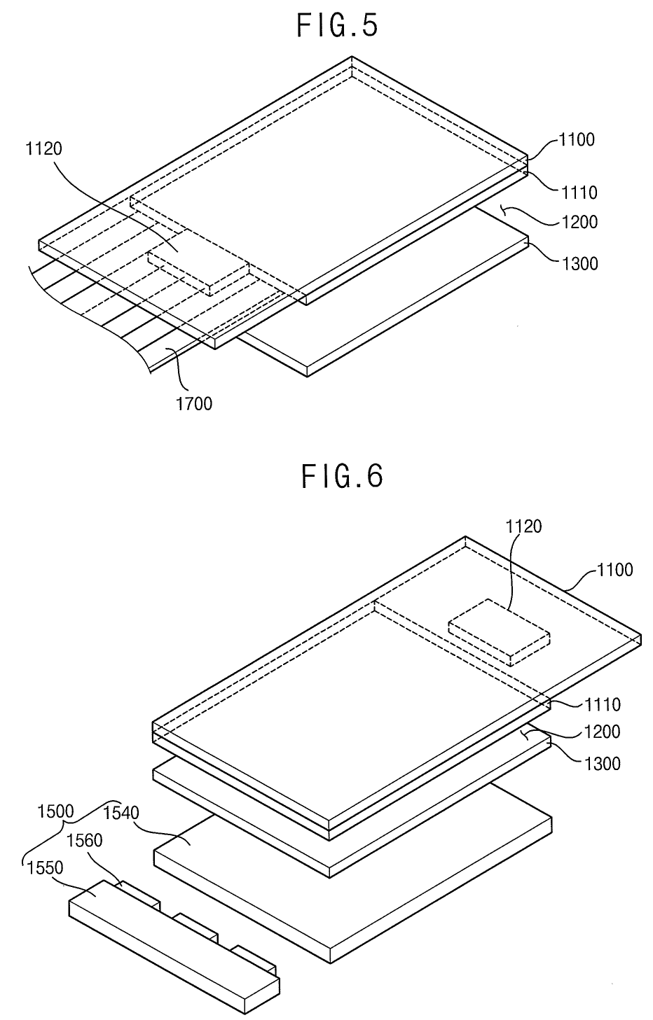

FIG. 5 is an exploded perspective view illustrating an LCD apparatus in accordance with an exemplary embodiment of the present invention.

Referring to FIG. 5, an LCD apparatus 1000 includes a first substrate 1100, a second substrate 1300, a liquid crystal layer 1200 and a driving circuit substrate 1700. The liquid crystal layer 1200 is disposed between the first substrate 1100 and the second substrate 1300.

The first substrate 1100 includes a display part 1110 and a sensor part 1120. The display part 1110 displays an image using liquid crystal. The sensor part 1120 is disposed in a peripheral area of the display part 1110 and detects external light.

The driving circuit substrate 1700 is disposed under the sensor part 1120 and blocks light provided to the sensor part 1120. For embodiments where the driving circuit substrate 1700 is not disposed under the sensor part 1120 due to the structure of the LCD panel, an additional light-blocking part may be present.

The light-blocking part, for example, may be a tape. The light-blocking part may include a black resin tape, a metallic layer and so on for blocking the light.

FIG. 6 is an exploded perspective view illustrating an LCD apparatus in accordance with an exemplary embodiment of the present invention.

An LCD apparatus 1000 includes a first substrate 1100, a second substrate 1300, a liquid crystal layer 1200 and a backlight assembly 1500. The liquid crystal layer 1200 is disposed between the first substrate 1100 and the second substrate 1300.

The first substrate 1100 includes a display part 1110 and a sensor part 1120. The display part 1110 displays an image using liquid crystal. The sensor part 1120 is disposed in a peripheral area of the display part 1110 and detects external light.

The backlight assembly 1500 includes a light unit part 1540, a light source driving part 1550 and a light source part 1560.

Even when the external light is not present, light is provided to the sensor part 1120 by the light source part 1560 of the backlight assembly 1500. The light provided by the light source part 1560 of the backlight assembly 1500 may generate a light-induced current in the sensor part. The light-induced current may deteriorate the sensitivity of the sensor part 1120 to the external light. When the sensor part 1120 is disposed on the gate electrode and light is provided to the sensor part 1120, the light may be detected by the sensor part 1120 even though sensitivity is low.

When the light generated by the light source part 1560 is provided to a lower portion of the sensor part 1120, noise is generated by the light source part 1560.

To reduce the noise, the sensor part 1120 is disposed in an area opposite to the light source part 1560 with respect to the display part 1110.

The sensor part 1120 is disposed in an area where the light source part 1560 has little influence, and thus the noise caused by the light provided by the light source part 1560 may be reduced.

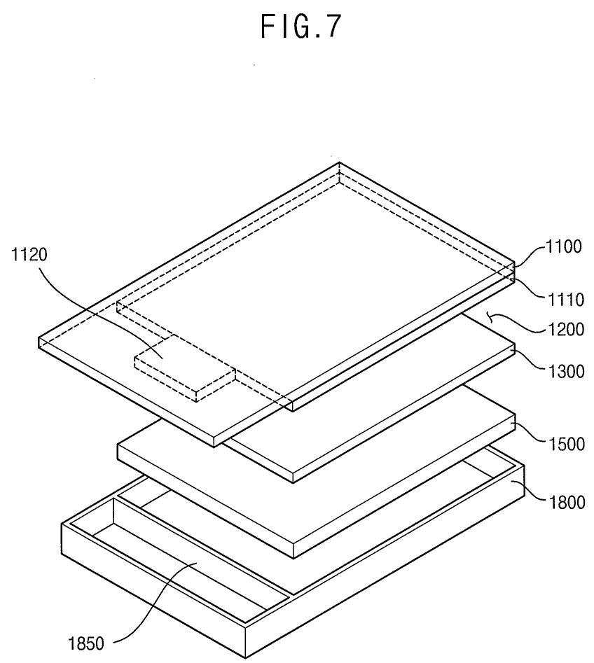

FIG. 7 is an exploded perspective view illustrating an LCD apparatus in accordance with an exemplary embodiment of the present invention.

An LCD apparatus includes a first substrate 1100, a second substrate 1300, a liquid crystal layer 1200, a backlight assembly 1500 and a mold frame 1800. The liquid crystal layer 1200 is disposed between the first substrate 1100 and the second substrate 1300.

The first substrate 1100 includes a display part 1110 and a sensor part 1120. The display part 1110 displays an image using liquid crystal. The sensor part 1120 is disposed in a peripheral area of the display part 1110 and detects external light.

The mold frame 1800 receives the first substrate 1100, the second substrate 1300 and the backlight assembly 1500. The mold frame 1800 includes a bottom part, a sidewall part extended from the bottom part and a partition 1850. The partition 1850 divides a receiving space for the backlight assembly 1500 and the sensor part 1120.

The partition 1850 is disposed between the backlight assembly 1500 and the sensor part 1120, and prevents the light leaked from the backlight assembly 1500 from irradiating onto a rear face of the sensor part 1120.

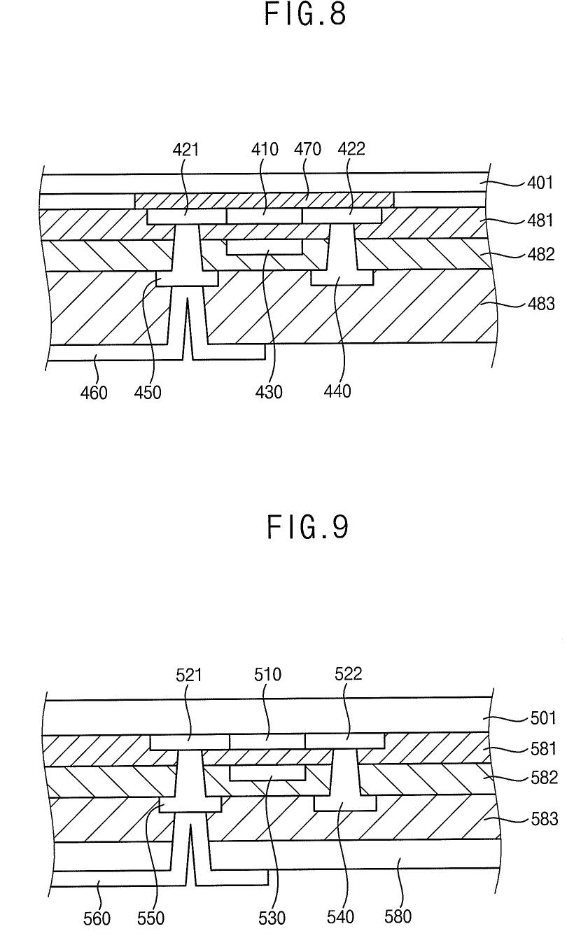

FIG. 8 is a cross-sectional view illustrating a first substrate 1100 of an LCD apparatus in accordance with an exemplary embodiment of the present invention.

In FIG. 8, the cross-section of the first substrate 1100 of the LCD apparatus is illustrated.

The display part is formed on a base substrate 401, and a polysilicon layer is formed on the display part. The polysilicon layer includes a channel part 410 and doping parts 421 and 422 formed at two opposite sides of the channel part 410.

The doping parts 421 and 422 are doped with n-type impurities or p-type impurities after the polysilicon layer is formed, thereby forming the channel part 410 and doping parts 421 and 422.

A first insulation layer 481 is formed on the channel part 410 and the doping parts 421 and 422. A gate electrode 430 is formed on the first insulation layer 481.

A second insulation layer 482 is formed on the gate electrode 430. A source electrode 440 and a drain electrode 450 are formed on the second insulation layer 482. The source electrode 440 penetrates the insulation layers 481 and 482 and makes contact with the doping part 422. The source electrode 440 is electrically connected to the doping part 422. The drain electrode 450 penetrates the insulation layers 481 and 482 and makes contact with the doping part 421. The drain electrode 450 is electrically connected to the doping part 421.

A third insulation layer 483 is formed on the source electrode 440 and the drain electrode 450. A pixel electrode 460 is formed on the third insulation layer 483, and the pixel electrode 460 penetrates the third insulation layer, and makes contact with the drain electrode 450. The pixel electrode 460 is electrically connected to the drain electrode 450.

A black matrix is arranged under/behind the base substrate 401 because the channel part 410, the gate electrode 430, the source and drain electrodes 440 and 450 and the pixel electrode 460 are arranged from the top down, in sequence, with respect to the first substrate 1100 of the LCD apparatus.

In the present embodiment, light is provided from the backlight assembly to a top portion of the LCD apparatus. The base substrate 401 is therefore the last part through which the light passes. Accordingly, the black matrix 470 is formed at the last portion through which light passes for displaying an image. Therefore, the black matrix 470 may be formed at an area closest to the base substrate 401.

The black matrix 470 is formed between a first area and the base substrate 401. The first area includes the channel part 410 and doping parts 421 and 422. An area of the black matrix 470 may be formed large enough to cover the first area. The black matrix 470 prevents light from leaking and thus may be used to display a clearer image.

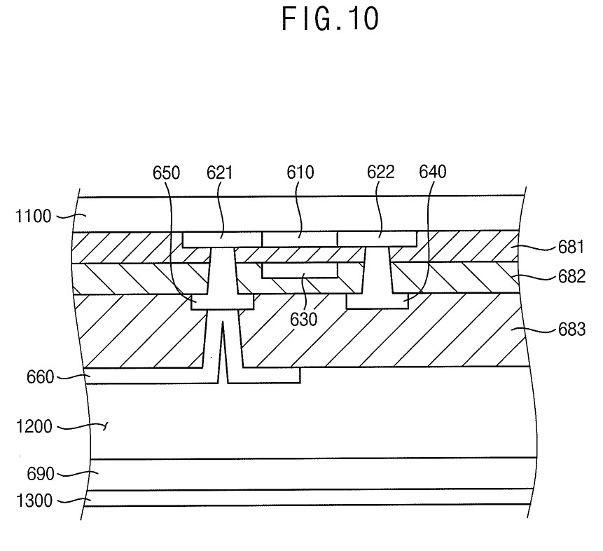

FIG. 9 is a cross-sectional view illustrating a first substrate of an LCD apparatus in accordance with an exemplary embodiment of the present invention.

The display part is formed on a base substrate 501, and polysilicon layer is formed on the display part. The polysilicon layer includes a channel part 510 and doping parts 521 and 522 formed at both sides of the channel part 510. The doping parts 521 and 522 are doped as n-type or p-type after the polysilicon layer is formed, thereby forming the channel part 510 and doping parts 521 and 522. A first insulation layer 581 is formed on the channel part 510 and doping parts 521 and 522, and a gate electrode 530 is formed on the first insulation layer 581.

A second insulation layer 582 is formed on the gate electrode 530. A source electrode 540 and a drain electrode 550 are formed on the second insulation layer 582. The source electrode 540 penetrates the insulation layers and makes contact with the doping part 522. The source electrode 540 is electrically connected to the doping part 522. The drain electrode 550 penetrates the insulation layers and makes contact with the doping part 521. The drain electrode 550 is electrically connected to the doping part 521. A third insulation layer 583 is formed on the source electrode 540 and the drain electrode 550. A pixel electrode 560 is formed on the third insulation layer 583, and the pixel electrode 560 penetrates the third insulation layer 583, and makes contact with the drain electrode 550. The pixel electrode 560 is electrically connected to the drain electrode 550.

A color filter layer 580 is formed on the third insulation layer 583. Because the LCD apparatus may not generate light by itself, light is transmitted via the color filter layer and displays color.

The LCD apparatus includes a color filter layer, and the color filter layer 580 is formed between the third insulation layer 583 and the pixel electrode 560 in the present embodiment.

FIG. 10 is a cross-sectional view illustrating a first substrate and a second substrate of an LCD apparatus in accordance with an exemplary embodiment.

A liquid crystal layer 1200 is disposed between a first substrate 1100 and a second substrate 1300. The first substrate 1100 includes a display part. The display part is substantially the same as the display part in FIG. 9 except for a color filter layer 690.

The color filter layer 690 is formed between the second substrate 1300 and the liquid crystal layer 1200. The color filter layer 690 is formed as a red color, a green color, and a blue color, correspondingly to a pixel of the first substrate 1100. A black matrix (not shown) may be formed between color pixels of the color filter layer.

A substrate of an LCD panel is disposed to expose a channel part of a sensor part to the exterior. The light sensitivity of the sensor part may be increased by the disposition of the substrate. Moreover, a light-blocking part is disposed under the sensor part. Noise caused by the backlight assembly may be reduced by the light-blocking part.

When external light is detected, an intensity of the backlight assembly is adjusted according to the detected external light. The light sensitivity of the sensor part may be improved by the disposition of the substrates. The noise of the backlight assembly is reduced by the light-blocking part. Therefore, the backlight assembly may be used effectively, and power consumption may be reduced.

Modifications, substitutions and variations from the exemplary embodiments herein described can be made in and to the materials, apparatus, configurations and methods of the display panels without departing from the spirit and scope of the present invention. The scope of the present invention should not be limited to that of the particular exemplary embodiments illustrated and described herein.

What is claimed is:

1. A liquid crystal display (LCD) apparatus comprising:
a first substrate including a display part and a sensor part, the sensor part being disposed in a peripheral area of the display part and sensing external light;
a second substrate opposite to the first substrate;
a liquid crystal layer disposed between the first substrate and the second substrate; and
a backlight assembly adjacent to the second substrate generating light.

2. The apparatus of claim 1, further comprising a control part controlling an amount of light supplied from the backlight assembly according to a light intensity detected by the sensor part.

3. The apparatus of claim 2, wherein the display part and the sensor part of the first substrate comprise a switching device and a sensor device, respectively, and each of the switching device and the sensor device comprises:
a polysilicon layer having a first doped part, a channel part and a second doped part;
a gate electrode formed on the channel part;
a source electrode making contact with the first doped part; and
a drain electrode making contact with the second doped part.

4. The apparatus of claim 3, wherein the first doped part of the sensor device is doped by p-type impurities, and the second doped part of the sensor part is doped by n-type impurities.

5. The apparatus of claim 3, wherein a light-blocking layer is formed under the polysilicon layer of the display part of the first substrate.

6. The apparatus of claim 3, wherein a protective layer is formed on the switching device of the display part of the first substrate and covers the switching device,
and a color filter layer is formed on the protective layer.

7. The apparatus of claim 1, further comprising a driving circuit substrate that drives the display part and is disposed between the sensor part and the backlight assembly and blocks light.

8. The apparatus of claim 7, wherein a driving chip is mounted on the driving circuit substrate,
and the driving chip of the driving circuit substrate is disposed under the sensor part and blocks light.

9. The apparatus of claim 1, further comprising a light-blocking part between the sensor part and the backlight assembly.

10. The apparatus of claim 9, wherein the light-blocking part has a thin-film shape and adheres to the sensor part.

11. The apparatus of claim 9, wherein an adhesive member is disposed between the sensor part and the light-blocking part to adhere the sensor part to the light-blocking part.

12. The apparatus of claim 1, wherein the backlight assembly comprises a light source at a first side of the backlight assembly,
and the sensor part is disposed at an opposite side of the backlight assembly with respect to the display part.

13. The apparatus of claim 1, further comprising a mold frame receiving the backlight assembly and an LCD panel including the first substrate, the second substrate and the liquid crystal layer.

14. The apparatus of claim 13, wherein the mold frame comprises a partition disposed between the backlight assembly and the sensor part to prevent light from leaking to the sensor part.

15. The apparatus of claim 1, further comprising a color filter layer formed on the second substrate.

16. A liquid crystal display (LCD) apparatus comprising:
an LCD panel that includes:
a first substrate having a display part displaying an image and a sensor part disposed in a peripheral area of the display part and sensing light;
a second substrate opposite to the first substrate; and
a liquid crystal layer between the first substrate and the second substrate;
a backlight assembly adjacent to the second substrate of the LCD panel and providing the LCD panel with light;
a driving circuit substrate driving the LCD panel; and
a control part controlling an amount of light supplied from the backlight assembly according to an intensity of light detected by the sensor part of the LCD panel.

17. The apparatus of claim 16, wherein the driving circuit substrate is disposed between the sensor part and the backlight assembly and blocks light.

18. The apparatus of claim 17, wherein the driving circuit substrate comprises a driving chip disposed under the sensor part and blocks light.

19. The apparatus of claim 16, wherein the backlight assembly comprises a light source at a side of the backlight assembly,
and the sensor part is disposed at an opposite side of the backlight assembly with respect to the display part.

20. The apparatus of claim 16, further comprising a mold frame receiving the backlight assembly and the LCD panel, the mold frame including a partition disposed between the backlight assembly and the sensor part and blocking light from leaking to the sensor part.
